(19) United States
(12) Patent Application Publication
(10) Pub. No.: US 2026/0160279 A1
(43) Pub. Date: Jun. 11, 2026

(54) Electro-Hydraulic Actuator Assembly with a Fluid Access Port

(71) Applicant: Parker-Hannifin Corporation, Cleveland, OH (US)

(72) Inventors: Jacob S. Larson, Falcon Heights, MN (US); William R. Klein, Maple Grove, MN (US); Michelle L. Vorlicek, Elk River, MN (US)

(21) Appl. No.: 19/180,415

(22) Filed: Apr. 16, 2025

Related U.S. Application Data
(60) Provisional application No. 63/637,443, filed on Apr. 23, 2024.

(51) Int. Cl. F15B 15/18; F15B 1/04; F15B 1/26; F15B 15/14

(52) U.S. Cl. CPC F15B 15/18; F15B 1/04; F15B 1/26; F15B 15/1428

(57) ABSTRACT

An example assembly includes: a pump; an electric motor that drives the pump; a cylinder actuator having a cylinder and a piston axially movable in the cylinder, wherein the piston has a piston head that divides an internal space of the cylinder into a first chamber and a second chamber, wherein the cylinder actuator receives fluid from the pump at the first chamber, and discharges fluid from the second chamber back to the pump, allowing the piston to move within the cylinder; a fluid reservoir that is fluidly coupled to the pump; an accumulator that is fluidly coupled to the fluid reservoir, wherein the accumulator stores a portion of fluid discharged from the second chamber; and an access port that provides external access to the fluid reservoir and the accumulator to enable providing fluid to, and drawing fluid from, the fluid reservoir and the accumulator.

### CROSS REFERENCE TO RELATED APPLICATION

The present application claims priority to U.S. Provisional Patent Application No. 63/637,443, filed on Apr. 23, 2024, the entire contents of which are herein incorporated by reference as if fully set forth in this description.

### BACKGROUND

An example elector-hydraulic actuator (EHA) is an assembly that includes a motor, a pump, and a hydraulic cylinder. The motor drives the pump, which provides fluid to the hydraulic cylinder to drive a piston disposed within the hydraulic cylinder. The EHA can be mounted directly to an implement to drive the implement via the piston.

Existing EHAs are typically configured as sealed units, where a predetermined fluid volume is filled into a reservoir of the EHA before a plug, cap, or other component is installed to seal the assembly off from an external environment. With this configuration, it may be difficult to change fluid during maintenance without fully disassembling the EHA, draining the EHA, before new fluid is provided to the EHA. Generally, existing methods of sealing the EHA using threaded-in ports or assembled components may hinder assembly, service, and operation.

Also, charge pressure may be beneficial in hydraulic systems to prevent cavitation in high speed or low temperature, high viscosity fluid applications. Using plugs does not enable providing an additional pressure charge of fluid above atmospheric pressure when desired.

Further, during operation, residual air can be drawn into the pump, aerating the fluid or cavitating the pump, thereby causing reduced force output or accelerated wear. Thus, it is typically desirable to remove air from fluid in the reservoir before the EHA is sealed off. Existing sealing methods do not enable removing air from fluid in a quick, efficient manner.

It is with respect to these and other considerations that the disclosure made herein is presented.

### SUMMARY

The present disclosure describes implementations that relate to an electro-hydraulic actuator with a fluid access port.

In a first example implementation, the present disclosure describes an assembly. The assembly includes: a pump; an electric motor that drives the pump; a cylinder actuator having a cylinder and a piston axially movable in the cylinder, wherein the piston has a piston head that divides an internal space of the cylinder into a first chamber and a second chamber, wherein the cylinder actuator receives fluid from the pump at the first chamber, and discharges fluid from the second chamber back to the pump, allowing the piston to move within the cylinder; a fluid reservoir that is fluidly coupled to the pump; an accumulator that is fluidly coupled to the fluid reservoir, wherein the accumulator stores a portion of fluid discharged from the second chamber; and an access port that provides external access to the fluid reservoir and the accumulator to enable providing fluid to, and drawing fluid from, the fluid reservoir and the accumulator.

In a second example implementation, the present disclosure describes a hydraulic system including the assembly of the first example implementation.

In a third example implementation, the present disclosure describes a method of operating the assembly of the first example implementation or the hydraulic system of the second example implementation.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE FIGURES

FIG. 1A illustrates a perspective view of an assembly of an electro-hydraulic actuator, according to an example implementation.

FIG. 1B illustrates a top view of the assembly of FIG. 1A, according to an example implementation.

FIG. 1C illustrates a side view of the assembly of FIG. 1A, according to an example implementation.

FIG. 2 illustrates a hydraulic schematic of the assembly of FIGS. 1A-1C, according to an example implementation.

FIG. 3 illustrates a transparent, partial top view of the assembly of FIGS. 1A-1C, according to an example implementation.

FIG. 4 illustrates a transparent, partial side view of the assembly of FIGS. 1A-1C, according to an example implementation.

FIG. 5 is a flowchart of method of operating the assembly of FIGS. 1A-1C, according to an example implementation.

### DETAILED DESCRIPTION

Disclosed herein is an EHA assembly with a fluid access port to allow access to a reservoir and accumulator of the EHA. This access port can enable providing an initial fluid filling to a particular level during assembly. The access port can also be used to charge the EHA with additional fluid to pressurize the reservoir/accumulator, thereby reducing the likelihood of pump cavitation and preventing leakage during operation. The access port can also be used as a diagnostic port without disrupting operation while in use. Further, the access port allows servicing the EHA (e.g., draining fluid and providing new fluid) during maintenance in a simple, efficient, leak-free manner.

In one example, the access port can have a fitting of a quick coupler or quick connector mounted to the access port. A mating fitting of the quick coupler can be screwed, snapped, or otherwise connected to the fitting of the access port to form a quick coupler that enables draining and providing fluid in a leak-free, quick manner that also reduces the likelihood of introducing air in the EHA. The quick coupler fitting mounted to the access port can also enable mounting a diagnostic device, such as a sensor (e.g., a pressure sensor), to monitor performance of the EHA.

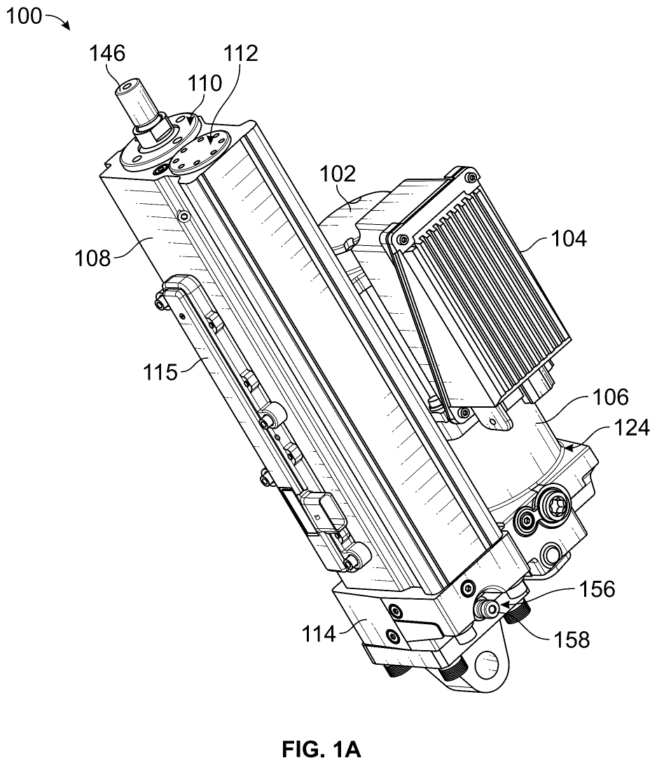

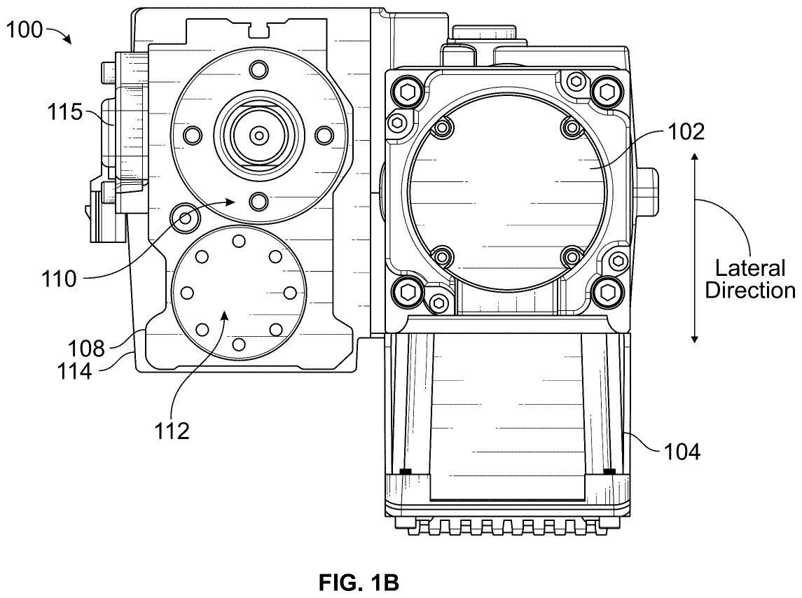

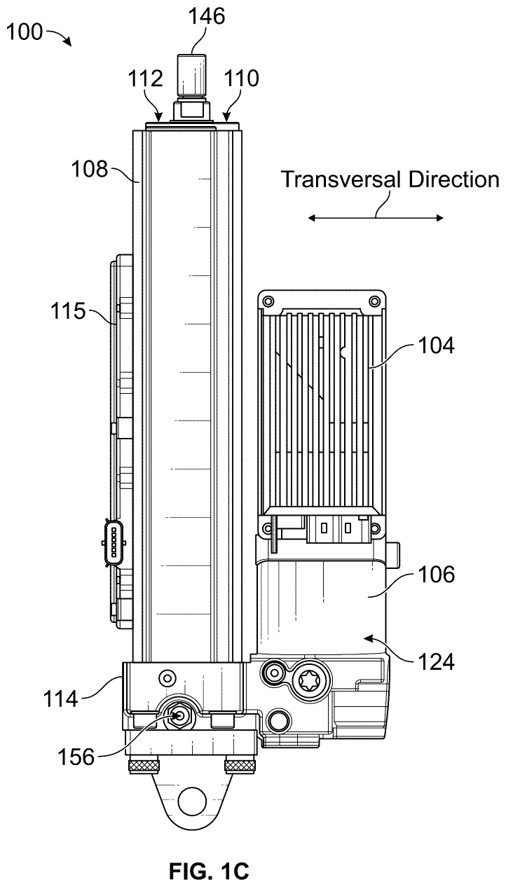

FIG. 1A illustrates a perspective view of an assembly 100 of an EHA, FIG. 1B illustrates a top view of the assembly 100, and FIG. 1C illustrates a side view of the assembly 100, according to an example implementation. FIGS. 1A-1C are described together.

The assembly 100 includes an electric motor 102 and a controller 104 that controls operation of the electric motor 102. The electric motor 102 can be any type of electric motors, e.g., Alternating Current (AC) motors, Direct Current (DC), brushless DC motors, synchronous motors, induction motors, etc.

In an example, the controller 104 includes an inverter. The inverter can be configured as a power converter that converts DC power received at the inverter (e.g., received from a battery) to three-phase, AC power that can be provided to wire windings of a stator of the electric motor 102 to drive the electric motor 102. The controller 104 may also have a microprocessor that provides a pulse width modulated (PWM) signal to operate the power converter, for example.

The assembly 100 also includes a pump 106 driven by the electric motor 102. The electric motor 102 controls the rate and direction of hydraulic fluid flow from the pump 106 by controlling the speed and direction of rotation of an output shaft of the electric motor 102 used to drive the pump 106, which is configured as a bi-directional fluid flow source.

The pump 106 can be any type of pump such as a piston pump, a gear pump, a vane pump, etc. The pump 106 is configured to be disposed in or immersed, at least partially, in a fluid reservoir 124. The fluid reservoir 124 can be at least partially formed in the pump housing. The fluid reservoir 124 may also be formed at least partially in the manifold 114. In an example, the fluid reservoir 124 may be fully incorporated into the manifold 114.

The assembly 100 further includes a housing 108, which houses a cylinder actuator 110 and an accumulator 112. The accumulator 112 can be a piston-type or bladder-type accumulator, as examples.

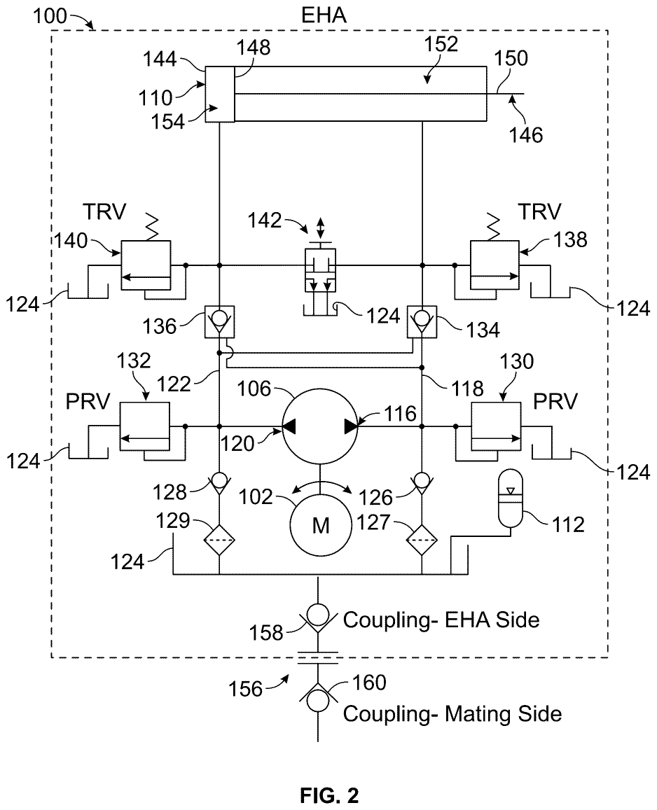

The assembly 100 also includes a manifold 114. The manifold 114 can be formed as a metallic block (e.g., casting) that has a plurality of fluid passages formed (e.g., drilled) therein. Such fluid passages enable fluid flow between the pump 106, the cylinder actuator 110, and the accumulator 112. The manifold 114 further includes valves disposed therein to control direction of fluid flow, control pressure levels, mode of operation of the cylinder actuator 110, etc. The such valves are not shown mounted to the manifold 114 to reduce visual clutter in the drawings, but are represented symbolically in the schematic of FIG. 2 described below.

In an example, the assembly 100 can also include a linear position sensor 115 mounted to the housing 108. The linear position sensor 115 is configured to provide sensor information indicative of a position of a piston 146 of the cylinder actuator 110.

In an example, the linear position sensor 115 may be an anisotropic magnetoresistive (AMR) sensor. An AMR sensor may be made up of a thin film of alloy on a glass or silicon board. Such AMR sensor measures the position of the piston 146 by interacting with a magnet that may be embedded in the piston 146 (e.g., in a piston head of the piston 146) and measuring the angle of a magnetic field by detecting changes in an electrical resistance of the alloy material.

Particularly, such AMR sensor may operate by interacting with the magnet where the magnet generates an external magnetic field that is applied in a direction perpendicular to the axial direction of the piston 146. The electric resistance value of the alloy material of the AMR sensor changes according to the magnetic field strength or intensity. AMR sensors utilize this effect to determine the position of the piston 146.

Notably and advantageously, more than one AMR sensor could be used. If the linear position sensor 115 uses multiple AMR sensors distributed along a length of the cylinder actuator 110, the range of movement or stroke of the piston 146 can be divided into a set of ranges, and each sensor of the sensors is configured to detect position of the piston 146 in a particular respective range of the set of ranges. This may enhance position sensing accuracy. Also, using multiple sensors may facilitate cancelling atmospheric or environmental magnetic noise.

Other types of magnetic sensors could be used. For example, another type of magnetic sensor can detect changes in magnetic flux as the magnet moves with the piston 146, and determine the position of the magnet and the piston 146 based on such changes in the magnetic flux.

Also, any other type of position sensor can be used. For instance, a Linear Variable Differential Transformer (LVDT), which is a device that converts an object's linear motion into an electrical signal, can be used. Regardless of whether one or multiple sensor are used, and the type of sensor, the one or more sensors may generate sensor information, e.g., a voltage signal, that is indicative of the position of the piston 146.

In the configuration of the assembly 100 as depicted in FIG. 1, the cylinder actuator 110 and the accumulator 112 are coplanar and are disposed side by side, with the accumulator 112 being shifted laterally relative to the cylinder actuator 110. The electric motor 102 and the pump 106 are disposed in a plane that is parallel to, and shifted transversely from, a respective plane of the cylinder actuator 110 and the accumulator 112.

The manifold 114 extends transversely to be fluidly coupled to both the pump 106, on a first side of the manifold 114, and the cylinder actuator 110 and the accumulator 112, on a second side of the manifold 114. The manifold 114 has fluid passages that provide fluid communication therebetween the pump 106, the fluid reservoir 124, the cylinder actuator 110, and the accumulator 112.

FIG. 2 illustrates a hydraulic schematic of the assembly 100, according to an example implementation. The pump 106 has a first pump port 116 connected to a fluid line 118, and has a second pump port 120 connected to a fluid line 122. The term “fluid flow line” is used throughout herein to indicate one or more fluid passages, conduits or the like that can be formed in the manifold 114 and the housing 108 to provide the indicated fluid connection.

The pump 106 is immersed, at least partially, in the fluid reservoir 124. The fluid reservoir 124 is configured as a low pressure fluid tank or container storing fluid at low pressure (e.g., atmospheric pressure or pressure in a range between 5 and 100 pounds per square inch (psi), for example). The fluid reservoir 124 is drawn in several locations in the assembly 100 to reduce visual clutter in the drawing. It should be understood, however, that the assembly 100 can include one fluid reservoir.

Further, the fluid reservoir 124 is fluidly coupled to the accumulator 112 via fluid passages or conduits in the manifold 114.

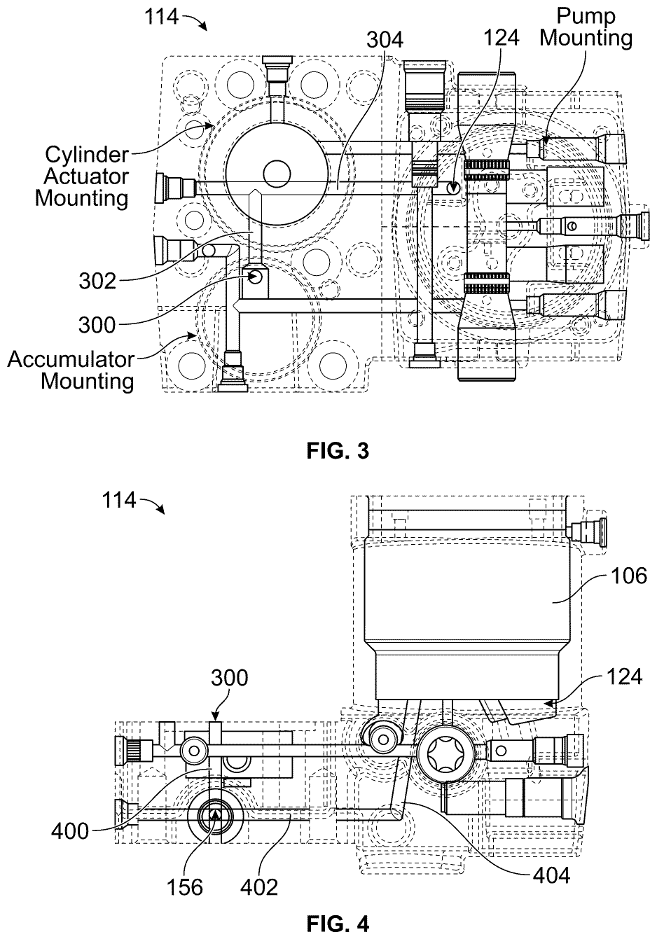

FIG. 3 illustrates a transparent, partial top view of the assembly 100, according to an example implementation. The pump 106, cylinder actuator 110, and the accumulator 112 are not shown in FIG. 3, but their mounting locations are pointed out in the drawing.

As depicted in FIG. 3, the manifold 114 has an accumulator port 300 that is fluidly coupled to the accumulator 112. The accumulator port 300 is fluidly coupled to the fluid reservoir 124 via fluid passage 302 and fluid passage 304 formed in the manifold 114.

Referring to FIGS. 2-3 together, the accumulator 112 is in fluid communication with the fluid reservoir 124 (via the fluid passages 302, 304 in the manifold 114), and the accumulator 112 may thus be considered as an extension or enlargement of the volume of the fluid reservoir 124. This allows storing a larger amount of fluid in a space-efficient manner.

Referring now to FIG. 2, the fluid line 118 includes a check valve 126 that prevents back flow from the pump 106 to the fluid reservoir 124, but rather allows fluid from the first pump port 116 to flow to the cylinder actuator 110 or from the cylinder actuator to the first pump port 116. Fluid can also be drawn from the fluid reservoir 124 through a filter 127 to the fluid line 118. The filter 127 may facilitate cleaning hydraulic fluid before flowing to the first pump port 116.

Similarly, the fluid line 122 includes a check valve 128 that prevents back flow from the pump 106 to the fluid reservoir 124, but rather allows fluid from the pump 106 to flow to the cylinder actuator 110. A filter 129 may facilitate cleaning the hydraulic fluid.

The assembly 100 can further include a pressure relief valve 130 configured to protect the first pump port 116 and connected between the fluid line 118 and the fluid reservoir 124. The assembly 100 can also include a pressure relief valve 132 configured to protect the second pump port 120 and connected between the fluid line 122 and the fluid reservoir 124. The pressure relief valves 130, 132 are configured to open and provide a fluid flow path to the fluid reservoir 124 when pressure level of fluid in the fluid lines 118, 122, respectively, exceeds a threshold pressure value. This way, the pump 106 is protected from over-pressurization.

The assembly 100 further includes a pilot-operated (PO) check valve 134 disposed in the fluid line 118, and also includes a PO check valve 136 disposed in the fluid line 122. The PO check valve 134 has a pilot port connected to the fluid line 122, and the PO check valve 136 has a pilot port connected to the fluid line 118.

In an example, the assembly 100 can also include a thermal relief valve 138 disposed downstream of the PO check valve 134 in the fluid line 118, and a thermal relief valve 140 disposed downstream of the PO check valve 136 in the fluid line 122. The thermal relief valves 138, 140 protect the assembly 100 from excessive pressure buildup caused by overheating and expansion of fluid in the fluid lines 118, 122. Particularly, the thermal relief valves 138, 140 open and release pressure when the temperature of fluid exceeds a certain threshold temperature value. Such threshold temperature is typically set just below the temperature at which the assembly 100 (any of the components thereof) is likely to be damaged or fail due to overheating.

The assembly 100 includes a valve assembly 142 that enables flow from one of the chambers (the larger chamber) of the cylinder actuator 110 to the fluid reservoir 124. The valve assembly 142 may also enable operating the cylinder actuator 110 in a float mode where both chambers are connected to the fluid reservoir 124.

In examples, as mentioned above, the valves of the assembly 100 may be disposed in the manifold 114. For example, the check valves 126, 128, the filters 127, 129, the pressure relief valves 130, 132, the PO check valves 134, 136, the thermal relief valves 138, 140, and the valve assembly 142 may be disposed in respective valve cavities in the manifold 114.

The cylinder actuator 110 includes a cylinder 144 and the piston 146 that is axially movable within the cylinder 144. The piston 146 includes a piston head 148 and a rod 150 extending from the piston head 148 along a central longitudinal axis of the cylinder 144. The rod 150 can be coupled to an implement controlled by the EHA of the assembly 100. The piston head 148 divides the internal space of the cylinder 144 into a first chamber 152 (e.g., rod-side chamber) and a second chamber 154 (e.g., head-side chamber).

The piston head 148 can have a diameter DH, and the rod 150 can have a diameter DR. As such, fluid in the second chamber 154 interacts with a cross-sectional surface area of piston head 148 that can be referred to as piston head area and is equal to

$${A}_{H} = π \frac{{D}_{H}^{2}}{4} .$$

On the other hand, fluid in the first chamber 152 interacts with an annular surface area of the piston 146 that can be referred to as piston annular area

$${A}_{Annular} = π \frac{{D}_{H}^{2} - {D}_{R}^{2}}{4} .$$

The area A_{Annular} is smaller than the piston head area A_{H}. Thus, as the piston 146 extends (e.g., moves to the right in FIG. 2) or retracts (e.g., moves to the left in FIG. 2) within the cylinder 144, the amount of fluid flow Q_{H} flowing into or being discharged from the second chamber 154 is greater than the amount of fluid flow Q_{Annular} being discharged from or flowing into the first chamber 152. Particularly, if the piston 146 is moving at a particular velocity V, then Q_{H}=A_{H}V is greater than Q_{Annular}=A_{Annular}V. The difference in flow can be determined as Q_{Rod}=Q_{H}−Q_{Annular}=A_{R}V, where A_{R} is the cross-sectional area of the rod 150 and is equal to

$$π \frac{{D}_{R}^{2}}{4} .$$

With this configuration, the cylinder actuator 110 can be referred to as an unbalanced actuator as fluid flow to/from one chamber thereof is not equal to fluid flow to/from the other chamber.

In one mode of operation, the electric motor 102 is not actuated to drive the pump 106, and thus no fluid is provided to the cylinder actuator 110. The valve assembly 142 and the PO check valves 134, 136 also block fluid from being discharged from the cylinder actuator 110. As such, in this mode, the cylinder actuator 110 operates in a load-holding mode where the piston 146 remains locked in position, and no fluid is provided to or is discharged from the cylinder actuator 110. In some example implementations, a counter-balance valve may be added between the PO check valve 134 and the first chamber 152. Such counter-balance valve may also be mounted in the manifold 114.

When it is desirable to move the piston 146 (e.g., to extend or retract the piston 146), the controller 104 can send command signals to operate the electric motor 102. The electric motor 102 then drives the pump 106 to provide fluid flow to the cylinder actuator 110.

For example, to retract the piston 146, the electric motor 102 can drive the pump 106 in a first direction such that the pump 106 provides fluid flow through the first pump port 116 to the fluid line 118. Fluid is then provided through the PO check valve 134 to the first chamber 152, causing the piston 146 to retract (e.g., move to the left in FIG. 2) and causing fluid to be discharged from the second chamber 154 to the fluid line 122. Fluid in the fluid line 118 is also provided as a pilot signal to the PO check valve 136 to open it and allow fluid discharged from the second chamber 154 of the cylinder actuator 110 to flow through the fluid line 122 to the second pump port 120. An excess portion of the fluid (e.g., Q_{Rod}) discharged from the second chamber 154 may also flow through the valve assembly 142 to the fluid reservoir 124, then to the accumulator 112 (e.g., via the fluid passages 304, 302). Thus, the accumulator 112 can be sized to store and provide at least a volume of fluid equal to the volume or the rod 150.

To extend the piston 146, the electric motor 102 can drive the pump 106 in a second direction (opposite the first direction) such that the pump 106 provides fluid flow through the second pump port 120 to the fluid line 122. Fluid is then provided the PO check valve 136 to the second chamber 154, causing the piston 146 to extend (e.g., move to the right in FIG. 2) and causing fluid to be discharged from the first chamber 152 to the fluid line 118.

Fluid in the fluid line 122 is also provided as a pilot signal to the PO check valve 134 to open it and allow fluid discharged from the first chamber 152 to flow through the fluid line 118 to the first pump port 116. Due to the volume difference between the first chamber 152 and the second chamber 154, the pump 106 can draw make up flow (e.g., Q_{Rod}) from the accumulator 112 through the fluid passages 302, 304 and the fluid reservoir 124 to join fluid discharged from the first chamber 152 at the first pump port 116.

The circuit shown in FIG. 2 is an example, and several variations can be implemented. For example, as mentioned above, a counter-balance valve can be added. In another example, rather than the valve assembly 142, one or more electrically-actuated valves can be mounted to the manifold 114 to operate the cylinder actuator 110 in various modes.

During the life of the assembly 100, maintenance operations may be performed. Such operations may involve draining hydraulic fluid from the assembly 100, providing new fluid to the assembly 100, increasing pressure of fluid (e.g., charging fluid in the fluid reservoir 124 and the accumulator 112 to a pressure higher than atmospheric pressure to prevent pump cavitation, etc.). Advantageously, the assembly 100 includes an access port 156 that facilitates such maintenance operations. The access port 156 also enables connecting a fluid source (e.g., an external pump) to the access port to provide an initial fill of fluid to the fluid reservoir 124 and/or the accumulator 112 at the beginning of life of the assembly 100.

Particularly, the access port 156 provides external access to the fluid reservoir 124 and the accumulator 112. The access port 156 is disposed in the manifold 114 as shown in FIG. 1A, 1C, as an example. However, the access port 156 can be placed in other locations (e.g., in the housing 108 to have access to the accumulator 112 directly).

FIG. 4 illustrates a transparent, partial side view of the assembly 100, according to an example implementation. Particularly, FIG. 4 shows a portion of the side view of FIG. 1C with a transparent view of the manifold 114 to show fluid passage connections between the access port 156 and the fluid reservoir 124.

As show, a fluid passage 400 in the manifold 114 fluidly couples the accumulator port 300 to the access port 156. Further, fluid passage 402 and fluid passage 404 also fluidly couples the access port 156 to the fluid reservoir 124. As such, the access port 156 is fluidly coupled to both the accumulator 112 and the fluid reservoir 124.

Referring back to FIG. 1A, in an example, a fitting 158 can be disposed in the access port 156. During normal operation of the assembly 100, the fitting 158 provides a sealed connection that prevents fluid leakage or aeration of (introducing air into) fluid.

Further, when maintenance operations are to be performed, a mating fitting 160 (shown schematically in FIG. 2) can be coupled to the fitting 158 to form a quick coupler. Such quick coupler configuration can be leak-free, and can prevent introducing air into the assembly 100.

The mating fitting 160 can be connected via a fluid line (e.g., tube, hose, pipe, etc.) to a source of fluid or a device that is capable of drawing fluid from the assembly 100. This way, old fluid can be withdrawn from the assembly 100, and new or fresh fluid can be provided into the assembly 100 in a leak-free, air-tight manner. Further, connecting to the assembly 100 via coupling the mating fitting 160 to the fitting 158 can enable charging fluid pressure (adding fluid to increase fluid pressure from a fluid source) in the fluid reservoir 124 and the accumulator 112 by introducing a particular amount of fluid under pressure, for example.

As such, the access port 156 advantageously facilitates access to the fluid reservoir 124 and the accumulator 112 during operation of the assembly 100 and during maintenance, without having to fully disassemble the assembly 100. As such, maintenance can be performed in a quick, efficient manner that prevents leakage or air introduction, to protect components of the assembly 100.

Further, the access port 156 can also be used as a diagnostic port without disrupting operation while in use. For example, a pressure sensor can be mounted to the access port, and such pressure sensor can thus provide sensor information indicative of pressure level in the fluid reservoir 124 and the accumulator 112 during operation of the assembly 100. Such sensor information can be used to diagnose any operational issues leading to unexpected pressure levels, for example.

In one example, the access port can have a fitting of a quick coupler or quick connector mounted to the access port. A mating fitting of the quick coupler can be screwed, snapped, or otherwise connected to the fitting of the access port to form a quick coupler that enables draining and providing fluid in a leak-free, quick manner that also reduces the likelihood of introducing air in the EHA. The quick coupler fitting mounted to the access port can also enable mounting a diagnostic device, such as a sensor (e.g., a pressure sensor), to monitor performance of the EHA.

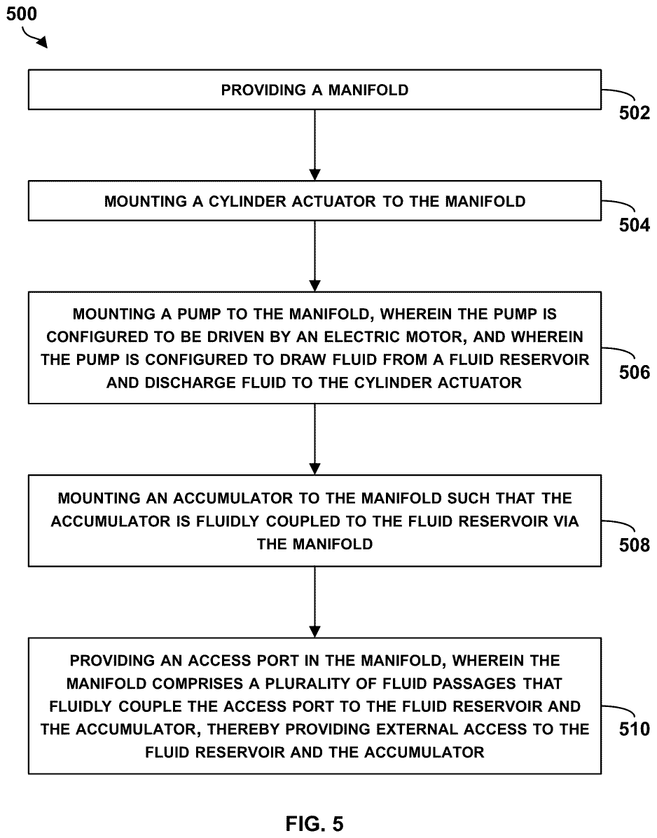

FIG. 5 is a flowchart of method 500 of operating the assembly 100, according to an example implementation. For example, the method 500 can be used to initiate operation of the assembly 100 by filling the fluid reservoir 124 with fluid, performing maintenance operation, performing diagnostic operations, etc.

The method 500 may include one or more operations, or actions as illustrated by one or more of blocks 502-510. Although the blocks are illustrated in a sequential order, these blocks may in some instances be performed in parallel, and/or in a different order than those described herein. Also, the various blocks may be combined into fewer blocks, divided into additional blocks, and/or removed based upon the desired implementation.

At block 502, the method 500 includes providing the manifold 114. The term “providing” as used herein, and for example with regard to any component such as the manifold 114 includes any action to make the component available for use, such as bringing the component to an apparatus or to a work environment for further processing (e.g., mounting other components).

At block 504, the method 500 includes mounting the cylinder actuator 110 to the manifold 114.

At block 506, the method 500 includes mounting the pump 106 to the manifold 114, wherein the pump 106 is configured to be driven by the electric motor 102, and wherein the pump 106 is configured to draw fluid from the fluid reservoir 124 and discharge fluid to the cylinder actuator 110.

At block 508, the method 500 includes mounting the accumulator 112 to the manifold 114 such that the accumulator 112 is fluidly coupled to the fluid reservoir 124 via the manifold 114.

At block 510, the method 500 includes providing the access port 156 in the manifold 114, wherein the manifold 114 comprises a plurality of fluid passages (e.g., the fluid passages 302-304, 400-404) that fluidly couple the access port 156 to the fluid reservoir 124 and the accumulator 112, thereby providing external access to the fluid reservoir 124 and the accumulator 112.

The method 500 can further include any of the steps or operations described above. For example, the method 500 can include providing fluid to, or drawing fluid from, the fluid reservoir 124 and the accumulator 112 via the access port 156. The method 500 can also include connecting a fluid source (e.g., an external pump) to the access port 156, and providing an initial fill of fluid to the fluid reservoir 124 to enable operating the pump 106 and the cylinder actuator 110.

The method 500 may also include draining fluid from the fluid reservoir 124 and the accumulator 112 via the access port 156, and replenishing the fluid reservoir 124 with fresh fluid via connecting a fluid source to the access port 156.

The method 500 may further include connecting a fluid source to the access port 156, and charging fluid pressure in the fluid reservoir 124 and the accumulator 112 by introducing a particular amount of fluid under pressure through the access port 156.

The method 500 may also include mounting a pressure sensor to the access port 156 to provide sensor information indicative of pressure level of fluid in the fluid reservoir 124 and the accumulator 112.

The method 500 can further include mounting the fitting 158 to the access port 156 to provide a sealed connection that prevents fluid leakage or aeration of fluid in the fluid reservoir 124 and the accumulator 112. A mating fitting can then be mounted to the fitting 158 to form a quick coupler that facilitates providing fluid to and drawing fluid from the fluid reservoir 124 and the accumulator 112 in a leak-free, air-tight manner.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform functions presented in the figures. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner.

By the term “substantially” or “about” it is meant that the recited characteristic, parameter, or value need not be achieved exactly, but that deviations or variations, including for example, tolerances, measurement error, measurement accuracy limitations and other factors known to those with skill in the art, may occur in amounts that do not preclude the effect the characteristic was intended to provide.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

Embodiments of the present disclosure can thus relate to one of the enumerated example embodiments (EEEs) listed below.

EEE 1 is an assembly of an electro-hydraulic actuator, the assembly comprising: a pump; an electric motor that drives the pump; a cylinder actuator having a cylinder and a piston axially movable in the cylinder, wherein the piston has a piston head that divides an internal space of the cylinder into a first chamber and a second chamber, wherein the cylinder actuator receives fluid from the pump at the first chamber, and discharges fluid from the second chamber back to the pump, allowing the piston to move within the cylinder; a fluid reservoir that is fluidly coupled to the pump; an accumulator that is fluidly coupled to the fluid reservoir, wherein the accumulator stores a portion of fluid discharged from the second chamber; and an access port that provides external access to the fluid reservoir and the accumulator to enable providing fluid to, and drawing fluid from, the fluid reservoir and the accumulator.

EEE 2 is the assembly of EEE 1, further comprising: a manifold having a plurality of fluid passages to facilitate fluid flow between the pump, the cylinder actuator, the fluid reservoir, and the accumulator, wherein the access port is disposed in the manifold.

EEE 3 is the assembly of EEE 2, further comprising: a housing in which the cylinder actuator and the accumulator are disposed, such that the cylinder actuator and the accumulator are coplanar.

EEE 4 is the assembly of EEE 3, wherein the electric motor and the pump are disposed in a plane that is shifted transversely relative to a respective plane of the cylinder actuator and the accumulator.

EEE 5 is the assembly of any of EEEs 2-4, wherein the manifold extends transversely to be fluidly coupled to both the pump on a first side, and the cylinder actuator and the accumulator on a second side, and provide fluid communication therebetween.

EEE 6 is the assembly of any of EEEs 1-5, wherein the pump is immersed, at least partially, in the fluid reservoir.

EEE 7 is the assembly of any of EEEs 1-6, further comprising: a manifold to which the accumulator and the fluid reservoir are mounted, wherein the manifold comprises an accumulator port for fluid communication with the accumulator, and wherein the manifold comprises: one or more fluid passages that fluidly couple the accumulator port to the access port, and one or more respective fluid passages that fluidly couple the access port to the fluid reservoir.

EEE 8 is the assembly of any of EEEs 1-7, further comprises: a fitting mounted to the access port, wherein the fitting provides a sealed connection that prevents fluid leakage or aeration of fluid in the fluid reservoir and the accumulator.

EEE 9 is the assembly of EEE 8, wherein a mating fitting is mounted to the fitting to form a quick coupler that facilitates providing fluid to and drawing fluid from the fluid reservoir and the accumulator in a leak-free, air-tight manner.

EEE 10 is a method of forming and/or operating the assembly of any of EEEs 1-9. For example, the method comprises: providing a manifold; mounting a cylinder actuator to the manifold; mounting a pump to the manifold, wherein the pump is configured to be driven by an electric motor, and wherein the pump is configured to draw fluid from a fluid reservoir and discharge fluid to the cylinder actuator; mounting an accumulator to the manifold such that the accumulator is fluidly coupled to the fluid reservoir via the manifold; and providing an access port in the manifold, wherein the manifold comprises a plurality of fluid passages that fluidly couple the access port to the fluid reservoir and the accumulator, thereby providing external access to the fluid reservoir and the accumulator.

EEE 11 is the method of EEE 10, further comprising: providing fluid to, or drawing fluid from, the fluid reservoir and the accumulator via the access port.

EEE 12 is the method of any of EEEs 10-11, further comprising: connecting a fluid source to the access port; and providing an initial fill of fluid to the fluid reservoir to enable operating the pump and the cylinder actuator.

EEE 13 is the method of any of EEEs 10-12, further comprising: draining fluid from the fluid reservoir and the accumulator via the access port; and replenishing the fluid reservoir with fresh fluid via connecting a fluid source to the access port.

EEE 14 is the method of any of EEEs 10-13, further comprising: connecting a fluid source to the access port; and charging fluid pressure in the fluid reservoir and the accumulator by introducing a particular amount of fluid under pressure through the access port.

EEE 15 is the method of any of EEEs 10-14, further comprising: mounting a pressure sensor to the access port, wherein the pressure sensor is configured to provide sensor information indicative of pressure level of fluid in the fluid reservoir and the accumulator.

EEE 16 is the method of any of EEEs 10-15, further comprising: mounting a fitting to the access port to provide a sealed connection that prevents fluid leakage or aeration of fluid in the fluid reservoir and the accumulator.

EEE 17 is the method of EEE 16, further comprising: mounting a mating fitting to the fitting to form a quick coupler that facilitates providing fluid to and drawing fluid from the fluid reservoir and the accumulator in a leak-free, air-tight manner.

EEE 18 is the method of any of EEEs 10-17, wherein mounting the cylinder actuator and the accumulator to the manifold comprises: mounting a housing, in which the cylinder actuator and the accumulator are disposed, to the manifold such that the cylinder actuator and the accumulator are coplanar.

EEE 19 is the method of EEE 18, wherein mounting the pump to the manifold comprises: mounting the pump in a plane that is shifted transversely relative to a respective plane of the cylinder actuator and the accumulator.

EEE 20 is the method of any of EEEs 10-19, wherein mounting the pump, the cylinder actuator, and the accumulator to the manifold comprises: mounting the pump, the cylinder actuator, and the accumulator to the manifold such that the manifold extends transversely to be fluidly coupled to both the pump on a first side, and the cylinder actuator and the accumulator on a second side, and provide fluid communication therebetween.

What is claimed is:

1. An assembly of an electro-hydraulic actuator, the assembly comprising:
a pump;
an electric motor that drives the pump;
a cylinder actuator having a cylinder and a piston axially movable in the cylinder, wherein the piston has a piston head that divides an internal space of the cylinder into a first chamber and a second chamber, wherein the cylinder actuator receives fluid from the pump at the first chamber, and discharges fluid from the second chamber back to the pump, allowing the piston to move within the cylinder;
a fluid reservoir that is fluidly coupled to the pump;
an accumulator that is fluidly coupled to the fluid reservoir, wherein the accumulator stores a portion of fluid discharged from the second chamber; and
an access port that provides external access to the fluid reservoir and the accumulator to enable providing fluid to, and drawing fluid from, the fluid reservoir and the accumulator.

2. The assembly of claim 1, further comprising:
a manifold having a plurality of fluid passages to facilitate fluid flow between the pump, the cylinder actuator, the fluid reservoir, and the accumulator, wherein the access port is disposed in the manifold.

3. The assembly of claim 2, further comprising:
a housing in which the cylinder actuator and the accumulator are disposed, such that the cylinder actuator and the accumulator are coplanar.

4. The assembly of claim 3, wherein the electric motor and the pump are disposed in a plane that is shifted transversely relative to a respective plane of the cylinder actuator and the accumulator.

5. The assembly of claim 2, wherein the manifold extends transversely to be fluidly coupled to both the pump on a first side, and the cylinder actuator and the accumulator on a second side, and provide fluid communication therebetween.

6. The assembly of claim 1, wherein the pump is immersed, at least partially, in the fluid reservoir.

7. The assembly of claim 1, further comprising:
a manifold to which the accumulator and the fluid reservoir are mounted, wherein the manifold comprises an accumulator port for fluid communication with the accumulator, and wherein the manifold comprises: one or more fluid passages that fluidly couple the accumulator port to the access port, and one or more respective fluid passages that fluidly couple the access port to the fluid reservoir.

8. The assembly of claim 1, further comprises:
a fitting mounted to the access port, wherein the fitting provides a sealed connection that prevents fluid leakage or aeration of fluid in the fluid reservoir and the accumulator.

9. The assembly of claim 8, wherein a mating fitting is mounted to the fitting to form a quick coupler that facilitates providing fluid to and drawing fluid from the fluid reservoir and the accumulator in a leak-free, air-tight manner.

10. A method comprising:
providing a manifold;
mounting a cylinder actuator to the manifold;
mounting a pump to the manifold, wherein the pump is configured to be driven by an electric motor, and wherein the pump is configured to draw fluid from a fluid reservoir and discharge fluid to the cylinder actuator;
mounting an accumulator to the manifold such that the accumulator is fluidly coupled to the fluid reservoir via the manifold; and
providing an access port in the manifold, wherein the manifold comprises a plurality of fluid passages that fluidly couple the access port to the fluid reservoir and the accumulator, thereby providing external access to the fluid reservoir and the accumulator.

11. The method of claim 10, further comprising:
providing fluid to, or drawing fluid from, the fluid reservoir and the accumulator via the access port.

12. The method of claim 10, further comprising:
connecting a fluid source to the access port; and
providing an initial fill of fluid to the fluid reservoir to enable operating the pump and the cylinder actuator.

13. The method of claim 10, further comprising:
draining fluid from the fluid reservoir and the accumulator via the access port; and
replenishing the fluid reservoir with fresh fluid via connecting a fluid source to the access port.

14. The method of claim 10, further comprising:
connecting a fluid source to the access port; and
charging fluid pressure in the fluid reservoir and the accumulator by introducing a particular amount of fluid under pressure through the access port.

15. The method of claim 10, further comprising:
mounting a pressure sensor to the access port, wherein the pressure sensor is configured to provide sensor information indicative of pressure level of fluid in the fluid reservoir and the accumulator.

16. The method of claim 10, further comprising:
mounting a fitting to the access port to provide a sealed connection that prevents fluid leakage or aeration of fluid in the fluid reservoir and the accumulator.

17. The method of claim 16, further comprising:
mounting a mating fitting to the fitting to form a quick coupler that facilitates providing fluid to and drawing fluid from the fluid reservoir and the accumulator in a leak-free, air-tight manner.

18. The method of claim 10, wherein mounting the cylinder actuator and the accumulator to the manifold comprises:
mounting a housing, in which the cylinder actuator and the accumulator are disposed, to the manifold such that the cylinder actuator and the accumulator are coplanar.

19. The method of claim 18, wherein mounting the pump to the manifold comprises:
mounting the pump in a plane that is shifted transversely relative to a respective plane of the cylinder actuator and the accumulator.

20. The method of claim 10, wherein mounting the pump, the cylinder actuator, and the accumulator to the manifold comprises:
mounting the pump, the cylinder actuator, and the accumulator to the manifold such that the manifold extends transversely to be fluidly coupled to both the pump on a first side, and the cylinder actuator and the accumulator on a second side, and provide fluid communication therebetween.
